(19) United States
(12) Patent Application Publication
(10) Pub. No.: US 2023/0312786 A1
(43) Pub. Date: Oct. 5, 2023

(54) PRODUCTION METHOD FOR CYCLIC OLEFIN COPOLYMER

(71) Applicant: Polyplastics Co., Ltd., Tokyo (JP)

(72) Inventors: Hiroyuki KOMATSU, Fuji-shi (JP); Tomoyuki TADA, Fuji-shi (JP)

(21) Appl. No.: 18/006,803

(22) PCT Filed: Jun. 4, 2021
(86) PCT No.: PCT/JP2021/021412

§ 371 Date: Jan. 25, 2023

(30) Foreign Application Priority Data
Jul. 31, 2020 (JP) 2020-130503

(51) Int. Cl. C08F 210/02

(52) U.S. Cl. CPC C08F 210/02

(57) ABSTRACT

A production method for a cyclic olefin copolymer, which is capable of efficiently producing a cyclic olefin copolymer by copolymerizing monomers including a norbornene monomer and ethylene while suppressing the formation of a polyethylene-like impurity and an excessive increase in molecular weight. In the polymerization of monomers including a norbornene monomer and ethylene in the presence of a metallocene catalyst, the metallocene catalyst having a ligand including a cyclopentadiene ring and a structure in which a heteroatom being N, O, S or P is bonded to a transition metal of Group IV of the periodic table and an sp2 carbon, and an alkylmetal compound are used in combination.

### TECHNICAL FIELD

The present invention relates to a method for producing a cyclic olefin copolymer including a structural unit derived from a norbornene monomer and a structural unit derived from ethylene.

### BACKGROUND ART

Cyclic olefin homopolymers and copolymers have low hygroscopicity and high transparency, and find use in various applications including the field of optical materials such as optical disc substrates, optical films, optical fibers. Copolymers of a cyclic olefin and ethylene, which are in widespread use as transparent resins, typify such cyclic olefin copolymers. The copolymers of a cyclic olefin and ethylene can have variable glass transition temperatures (Tg) depending on the copolymerization composition thereof, and therefore copolymers having the glass transition temperature thereof tuned in a wide temperature range can be produced (see, for example, Nonpatent Document 1).

Non-Patent Document 1: Incoronata, Tritto et al., Coordination Chemistry Reviews, 2006, vol. 250, pp. 212-241

### DISCLOSURE OF THE INVENTION

### Problems to Be Solved by the Invention

Unfortunately, the methods described in Nonpatent Document 1 have difficulty producing the copolymers of a cyclic olefin and ethylene in high yields. A possible solution for this difficulty is to conduct the polymerization using a highly active catalyst. However, when the polymerization is conducted using a highly active catalyst for the purpose of increasing the production efficiency of the cyclic olefin copolymers, the control of the molecular weight of the resulting copolymer is difficult, and a copolymer having an excessively increased molecular weight is often produced. In addition, when the polymerization is conducted using a highly active catalyst for the purpose of increasing the production efficiency of the cyclic olefin copolymers, a polyethylene-like impurity may be more readily co-produced. When a cyclic olefin copolymer contains a polyethylene-like impurity, such a cyclic olefin copolymer is highly likely to give a turbid solution upon the dissolution thereof in a solvent. As can also be understood from such a phenomenon, the inclusion of the polyethylene-like impurity in the cyclic olefin copolymer would impair the transparency of the cyclic olefin copolymer. Furthermore, the formation of the polyethylene-like impurity would require a process for filtering and removing the insoluble polyethylene-like impurity in a common production process for the production of the cyclic olefin copolymer, which would increase production costs.

The present invention takes the above circumstances into consideration, with an object of providing a production method for a cyclic olefin copolymer, which is capable of efficiently producing a cyclic olefin copolymer by copolymerizing monomers including a norbornene monomer and ethylene while suppressing the formation of a polyethylene-like impurity.

### Means for Solving the Problems

The present inventors found that the above-mentioned problems can be solved by using, in the polymerization of monomers including a norbornene monomer and ethylene in the presence of a metallocene catalyst, a metallocene catalyst having a ligand including a cyclopentadiene ring and a structure in which a heteroatom being N, O, S or P is bonded to a transition metal of Group IV of the periodic table and an sp2 carbon, and an alkylmetal compound in combination, to accomplish the present invention. More specifically, the present invention provides the following.

A first aspect of the present invention relates to a method for producing a cyclic olefin copolymer including a structural unit derived from a norbornene monomer and a structural unit derived from ethylene, the method including: charging at least the norbornene monomer and ethylene as monomers into a polymerization vessel;

polymerizing the monomers in the polymerization vessel in the presence of a metallocene catalyst and an alkylmetal compound, wherein
the alkylmetal compound includes at least one selected from an alkylaluminum compound having at least one alkyl group bonded to an Al atom, or an alkylzinc compound having at least one alkyl group bonded to a Zn atom, and
the metallocene catalyst has a ligand including a cyclopentadiene ring, and a structure in which a heteroatom being N, O, S or P is bonded to a transition metal of Group IV of the periodic table and an sp2 carbon.

A second aspect of the present invention relates to the method for producing a cyclic olefin copolymer according to the first aspect, wherein the metallocene catalyst is a metallocene compound represented by the following formula (a1) :

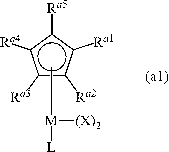

wherein in the formula (a1), M represents Ti, Zr or Hf, R^{a1} to

R^{a5} may be identical to or different from one another, and each independently represent a hydrogen atom, an organic substituent having 1 to 20 carbon atoms and optionally containing a heteroatom, or an inorganic substituent, wherein
two groups adjacent on the 5-membered ring of R^{a1} to R^{a5} are optionally bonded to each other to form a ring, X represents an organic substituent having 1 to 20 carbon atoms and optionally containing a heteroatom, or a halogen atom, and L represents a group represented by the following formula (ala) or (a1b):

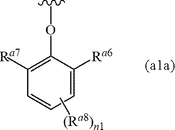

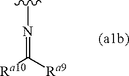

wherein in the formula (ala), R^{a6} to R^{a8} may be identical to or different from one another, and each independently represent a hydrogen atom, an organic substituent having 1 to 20 carbon atoms and optionally containing a heteroatom, or an inorganic substituent, and n1 is an integer of 0 to 3, and
wherein in the formula (a1b), R^{a9} and R^{a10} may be identical to or different from one another, and each independently represent a hydrogen atom, an organic substituent having 1 to 20 carbon atoms and optionally containing a heteroatom, or an inorganic substituent, and two groups R^{a9} and R^{a10} are optionally bonded to each other to form a ring.

A third aspect of the present invention relates to the method for producing a cyclic olefin copolymer according to the first or second aspect, wherein the transition metal of Group IV of the periodic table is Ti.

A fourth aspect of the present invention relates to the method for producing a cyclic olefin copolymer according to any one of the first to third aspects, wherein the polymerizing of the monomers is performed in the presence of the metallocene catalyst, the alkylmetal compound, and at least one selected from an aluminoxane or a borate compound.

A fifth aspect of the present invention relates to the method for producing a cyclic olefin copolymer according to any one of the first to fourth aspects, wherein the polymerizing of the monomers is performed in the presence of the metallocene catalyst, the alkylmetal compound, and an aluminoxane.

A sixth aspect of the present invention relates to the method for producing a cyclic olefin copolymer according to any one of the first to fifth aspects, wherein the alkylaluminum compound has at least one branched alkyl group bonded to an Al atom and having 2 to 8 carbon atoms, and the alkylzinc compound has at least one branched alkyl group bonded to a Zn atom and having 2 to 8 carbon atoms.

A seventh aspect of the present invention relates to the method for producing a cyclic olefin copolymer according to any one of the first to sixth aspects, wherein the alkylmetal compound includes one or more selected from the group consisting of trialkylaluminum, dialkylaluminum hydride, and dialkylzinc.

An eighth aspect of the present invention relates to the method for producing a cyclic olefin copolymer according to the seventh aspect, wherein the alkylmetal compound includes trialkylaluminum and/or dialkylaluminum hydride.

An ninth aspect of the present invention relates to the method for producing a cyclic olefin copolymer according to any one of the first to eighth aspects, wherein a DSC curve obtained in the measurement of a sample of the cyclic olefin copolymer according to the method defined in JIS K7121 using a differential scanning calorimeter in a nitrogen atmosphere under the condition of a rate of temperature increase of 20° C./min shows no peak of a melting point assigned to a polyethylene-like impurity in the range of 100° C. to 140° C.

### Effects of the Invention

The present invention can provide a production method for a cyclic olefin copolymer, which is capable of efficiently producing a cyclic olefin copolymer by copolymerizing monomers including a norbornene monomer and ethylene while suppressing the formation of a polyethylene-like impurity and an excessive increase in molecular weight.

### PREFERRED MODE FOR CARRYING OUT THE INVENTION

### Production Method for Cyclic Olefin Copolymer

In the production method for a cyclic olefin copolymer, a cyclic olefin copolymer including a structural unit derived from a norbornene monomer and a structural unit derived from ethylene is produced. The production method includes:
charging at least a norbornene monomer and ethylene as monomers into a polymerization vessel, and
polymerizing the monomers in the polymerization vessel in the presence of a metallocene catalyst and an alkylmetal compound.
Hereinafter, the charging of the norbornene monomer and ethylene as the monomer into the polymerization vessel is also referred to as a charging step. Further, the polymerizing of the monomers in the polymerization vessel in the presence of the metallocene catalyst and the alkylmetal compound is also referred to as a polymerization step.

The monomers in the polymerization vessel are polymerized in the presence of a metallocene catalyst and an alkylmetal compound. The metallocene catalyst used in polymerization has a ligand including a cyclopentadiene ring, and a structure in which a heteroatom being N, O, S or P is bonded to a transition metal of Group IV of the periodic table and an sp2 carbon.

In the copolymerization of ethylene and a norbornene monomer in the presence of a highly active catalyst, a copolymer having an excessively increased molecular weight is generally likely to be obtained, and ethylene homopolymerization is generally likely to proceed, more readily leading to the formation of a polyethylene-like impurity.

However, the polymerization of ethylene and the norbornene monomer using the metallocene catalyst having the structure as defined above under the alkylmetal compound is likely to produce the cyclic olefin copolymer in a favorable yield, while suppressing an excessive increase in the molecular weight of the copolymer, and the formation of the polyethylene-like impurity. The alkylmetal compound will be described later in detail.

### Charging Step

In the charging step, the norbornene monomer and ethylene are charged as the monomers into a polymerization vessel. Any monomer other than the norbornene monomer and ethylene may be charged into the polymerization vessel, so long as the effects of the present invention is not impaired. The sum of the ratio of the structural units derived from the norbornene monomer and the ratio of the structural units derived from ethylene in the cyclic olefin copolymer is typically preferably 80% by mass or more, more preferably 95% by mass or more, and even more preferably 98% by mass or more based on the total structural units.

The monomer other than the norbornene monomer and ethylene is not particularly limited so long as it is copolymerizable with the norbornene monomer and ethylene. Typical examples of such other monomer include α-olefins. Such an α-olefin may be substituted with at least one substituent such as a halogen atom.

The α-olefin is preferably a C3 to C12 α-olefin. The C3 to C12 α-olefin is not particularly limited, and examples thereof include propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, etc. Among these, 1-hexene, 1-octene and 1-decene are preferable.

The way of charging ethylene into the polymerization solution is not particularly limited, so long as the desired amount of ethylene can be charged into the polymerization vessel. Ethylene is typically charged into the polymerization vessel so as to achieve a charge pressure of ethylene in the polymerization vessel of 0.5 MPa or more. The charge pressure of ethylene is preferably 0.55 MPa or more, and more preferably 0.6 MPa or more. When the charge pressure of ethylene is high, the amount of the catalyst used per product polymer can be reduced. The upper limit of the charge pressure of ethylene is, for example, preferably 10 MPa or less, more preferably 5 MPa or less, and even more preferably 3 MPa or less.

A solvent may be charged into the polymerization vessel together with the norbornene monomer and ethylene. The solvent is not particularly limited, so long as the solvent does not inhibit the polymerization reaction. Examples of a preferable solvent include a hydrocarbon solvent and a halogenated hydrocarbon solvent, and a hydrocarbon solvent is preferable in light of its excellent handling characteristics, thermal stability and chemical stability. Specific examples of the preferable solvent include hydrocarbon solvents such as pentane, hexane, heptane, octane, isooctane, isododecane, mineral oils, cyclohexane, methylcyclohexane, decahydronaphthalene (decalin), benzene, toluene and xylene, and halogenated hydrocarbon solvents such as chloroform, methylene chloride, dichloromethane, dichloroethane and chlorobenzene.

In the case where the norbornene monomer is charged into the solvent, the lower limit of the concentration of the norbornene monomer is, for example, preferably 0.5% by mass or more, and more preferably 10% by mass or more. The upper limit of the concentration of the norbornene monomer is, for example, preferably 50% by mass or less, and even more preferably 35% by mass or less.

In the following, the norbornene monomer will be described.

### Norbornene Monomer

Examples of the norbornene monomer include norbornene and a substituted norbornene, and norbornene is preferable. One type of the norbornene monomer may be used alone, and two or more types of norbornene monomers may be used in combination.

The substituted norbornene is not particularly limited, and examples of a substituent included in the substituted norbornene include a halogen atom and a monovalent or divalent hydrocarbon group. Specific examples of the substituted norbornene include a compound represented by the following general formula (I).

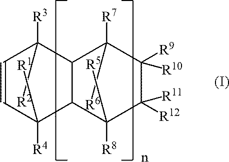

In the formula (I), R¹ to R¹² may be identical to or different from one another, and are each independently selected from the group consisting of a hydrogen atom, a halogen atom and a hydrocarbon group,
R⁹ and R¹⁰, and R¹¹ and R¹² optionally combine to form a divalent hydrocarbon group,
R⁹ or R¹⁰ and R¹¹ or R¹² optionally form a ring with each other. Further, n represents 0 or a positive integer, and
when n is two or more, R⁵ to R⁸ may be identical to or different from each other in the respective repeating units. In addition, when n is 0, at least one of R¹ to R⁴ and R⁹ to R¹² is not a hydrogen atom.

The substituted norbornene represented by the general formula (I) will be described. R¹ to R¹² in the general formula (I) may be identical to or different from one another, and are each independently selected from the group consisting of a hydrogen atom, a halogen atom and a hydrocarbon group.

Specific examples of R¹ to R⁸ include a hydrogen atom; a halogen atom such as fluorine, chlorine and bromine; an alkyl group having 1 to 20 carbon atoms, and the like, and R¹ to R⁸ may be different from each other, a part of R¹ to R⁸ may be different from one another, and all of R¹ to R⁸ may be identical to one another.

Further, specific examples of R⁹ to R¹² include a hydrogen atom; a halogen atom such as fluorine, chlorine and bromine; an alkyl group having 1 to 20 carbon atoms; a cycloalkyl group such as a cyclohexyl group; a substituted or unsubstituted aromatic hydrocarbon group such as a phenyl group, a tolyl group, an ethylphenyl group, an isopropylphenyl group, a naphthyl group and an anthryl group; an aralkyl group such as a benzyl group, a phenethyl group, and other aryl-group-substituted alkyl group, and the like, and R⁹ to R¹² may be different from each other, a part of R⁹ to R¹² may be different from one another, and all of R⁹ to R¹² may be identical to one another.

Specific examples of the divalent hydrocarbon group when R⁹ and R¹⁰, or R¹¹ and R¹² taken together form a divalent hydrocarbon group include an alkylidene group such as an ethylidene group, a propylidene group and an isopropylidene group, and the like.

When R⁹ or R¹⁰ and R¹¹ or R¹² form a ring with each other, the ring formed thereby may be a monocyclic or polycyclic ring, a bridged polycyclic ring, or a ring having a double bond, or may be a ring having a combination of these rings. In addition, these rings may have a substituent such as a methyl group.

Specific examples of the substituted norbornene represented by the general formula (I) include: bicyclic olefins such as 5-methyl-bicyclo[2.2.1]hept-2-ene, 5,5-dimethyl-bicyclo[2.2.1]hept-2-ene, 5-ethyl-bicyclo[2.2.1]hept-2-ene, 5-butyl-bicyclo[2.2.1]hept-2-ene, 5-ethylidene-bicyclo[2.2.1]hept-2-ene, 5-hexyl-bicyclo[2.2.1]hept-2-ene, 5-octyl-bicyclo[2.2.1]hept-2-ene, 5-octadecyl-bicyclo[2.2.1]hept-2-ene, 5-methylidene-bicyclo[2.2.1]hept-2-ene, 5-vinyl-bicyclo[2.2.1]hept-2-ene, 5-propenyl-bicyclo[2.2.1]hept-2-ene;
tricyclic olefins such as tricyclo[4.3.0.1^{2,5}]deca-3,7-diene (trivial name: dicyclopentadiene), tricyclo[4.3.0.1^{2,5}]deca-3-ene; tricyclo[4.4.0.1^{2,5}]undeca-3,7-diene or
tricyclo[4.4.0.1²,⁵]undeca-3,8-diene or a partially hydrogenated product thereof (or an adduct of cyclopentadiene and cyclohexene), i.e., tricyclo[4.4.0.1^{2,5}]undeca-3-ene; 5-cyclopentyl-bicyclo[2.2.1]hept-2-ene, 5-cyclohexyl-bicyclo[2.2.1]hept-2-ene, 5-cyclohexenylbicyclo[2.2.1]hept-2-ene and 5-phenyl-bicyclo[2.2.1]hept-2-ene;
tetracyclic olefins such as tetracyclo[4.4.0.1^{2,5}.1^{7,10}]dodeca-3-ene (which may be referred to simply as tetracyclododecene), 8-methyltetracyclo[4.4.0.1^{2,5}.1^{7,10}]dodeca-3-ene, 8-ethyltetracyclo[4.4.0.1^{2,5}.1^{7,10}]dodeca-3-ene, 8-methylidenetetracyclo[4 .4 . 0. 1^{2,5}.1^{7,10}]dodeca-3-ene, 8-ethylidenetetracyclo[4.4.0.1^{2,5}.1^{7,10}]dodeca-3-ene, 8-vinyltetracyclo [4,4.0.1^{2,5}.1^{7,10}] dodeca-3-ene and 8-propenyl-tetracyclo [4.4.0.1^{2,5} .1^{7,10}] dodeca-3-ene; and
polycyclic olefins such as 8-cyclopentyl-tetracyclo[4.4.0.1^{2,5}.1^{7,10}]dodeca-3-ene, 8-cyclohexyl-tetracyclo[4.4.0.1^{2,5}.1^{7,10}]dodeca-3-ene, 8-cyclohexenyl-tetracyclo [4.4.0.1^{2,5}.1^{7,10}]dodeca-3-ene, 8-phenyl-cyclopentyl-tetracyclo[4.4.0.1^{2,5}.1^{7,10}]dodeca-3-ene;
tetracyclo [7.4.1^{3,6}.0^{1,9}.0^{2,7} ] tetradeca -4, 9, 11, 13-tetraene (which may also be referred to as 1,4-methano-1,4,4a,9a-tetrahydrofluorene), tetracyclo [8.4.1^{4,7}. 0^{1,10}. 0^{3,8}] pentadeca-5,10,12,14-tetraene (which may also be referred to as 1,4-methano-1,4,4a,5,10,10a-hexahydroanthracene);
pentacyclo [6. 6. 1 .1^{3,6}_{.}0^{2,7}_{.}0^{9,14}]-4-hexadecene, pentacyclo [6.5.1.1^{3,6}_{.}0^{2,7}_{.}0^{9,13}]-4-pentadecene, pentacyclo [7 .4 .0 .0^{2,7}_{.} 1^{3,6}_{.} 1^{10,13}]-4-pentadecene;
heptacyclo [8. 7 . 0 .1^{2,9}. 1^{4,7}.1^{11,17}_{.} 0^{3,8}_{.} 0^{12,16}]-5-eicosene, heptacyclo [8.7.0.1^{2,9}. 0^{3,8}_{.}1^{4,7}. 0^{12,17}_{.}1^{13,16}] -14-eicosene; and a tetramer of cyclopentadiene.

Among these, alkyl-substituted norbornenes (e.g., bicyclo[2.2.1]hept-2-ene substituted with one or more alkyl group(s)), alkylidene-substituted norbornenes (e.g., bicyclo[2.2.1]hept-2-ene substituted with one or more alkylidene group(s)) are preferable, and 5-ethylidene-bicyclo[2.2.1]hept-2-ene (trivial name: 5-ethylidene-2-norbornene, or simply ethylidenenorbornene) is particularly preferable.

### Polymerization Step

In the polymerization step, the monomers in the polymerization vessel are polymerized in the presence of the metallocene catalyst and alkylmetal compound which each satisfy the predetermined requirements. The temperature during polymerization is not particularly limited. The temperature during polymerization is preferably 20° C. or higher, more preferably 30° C. or higher, even more preferably 50° C. or higher, still more preferably 60° C. or higher, and particularly preferably 70° C. or higher because of a favorable yield of the cyclic olefin copolymer, etc. The temperature during polymerization may be 80° C. or higher. The upper limit of the temperature during polymerization is not particularly limited, and may be, for example, 200° C. or lower, 140° C. or lower, or 120° C. or lower.

As the metallocene catalyst, a metallocene compound having a ligand including a cyclopentadiene ring, and a structure in which a heteroatom being N, O, S or P is bonded to a transition metal of Group IV of the periodic table and an sp2 carbon is used. Such a catalyst can efficiently produce the cyclic olefin copolymer, while suppressing the formation of a polyethylene-like impurity. In this specification, the sp2 carbon refers to a carbon atom forming an sp2 hybrid orbital.

In the metallocene catalyst, the heteroatom and the sp2 carbon may each have a substituent bonded thereto, and the substituent bonded to the heteroatom or the sp2 carbon is not particularly limited so long as the substituent does not impair the effects of the present invention.

Suitable examples of the ligand containing a cyclopentadiene ring, which is included in the metallocene catalyst, include cyclopentadiene, methylcyclopentadiene, dimethylcyclopentadiene, trimethylcyclopentadiene, tetramethylcyclopentadiene, pentamethylcyclopentadiene, n-butylcyclopentadiene, di-n-butylcyclopentadiene, tert-butylcyclopentadiene, di-tert-butylcyclopentadiene, adamantylcyclopentadiene, monomethylindene, dimethylindene, trimethylindene, tetramethylindene, 4,5,6,7-tetrahydroindene, fluorene, 5,10-dihydroindeno[1,2-b]indole, N-methyl-5,10-dihydroindeno[1,2-b]indole, N-phenyl-5,10-dihydroindeno[1,2-b]indole, 5,6-dihydroindeno[2,1-b]indole, N-methyl-5,6-dihydroindeno[2,1-b]indole and N-phenyl-5,6-dihydroindeno[2,1-b]indole.

The transition metal of Group IV of the periodic table in the metallocene catalyst is preferably Ti, Zr or Hf, and more preferably Ti.

Suitable examples of the metallocene catalyst described above include a metallocene compound represented by the following formula (a1).

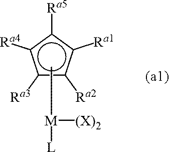

In the formula (a1), L represents a group represented by the following formula (ala) or (a1b).

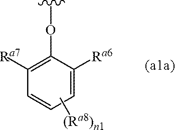

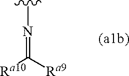

In the formula (a1), M represents Ti, Zr or Hf, and particularly preferably is Ti in light of ease of access to and production of the metallocene catalyst, as well as the activity of the catalyst, etc. R^{a1} to R^{a5} may be identical to or different from one another, and each independently represent a hydrogen atom, an organic substituent having 1 to 20 carbon atoms and optionally containing a heteroatom, or an inorganic substituent. Two groups adjacent on the 5-membered ring of R^{a1} to R^{a5} are optionally bonded to each other to form a ring. X represents an organic substituent having 1 to 20 carbon atoms and optionally containing a heteroatom, or a halogen atom. In the formula (ala), R^{a6} to R^{a8} may be identical to or different from one another, and each independently represent a hydrogen atom, an organic substituent having 1 to 20 carbon atoms and optionally containing a heteroatom, or an inorganic substituent, and n1 is an integer of 0 to 3. In the formula (a1b), R^{a9} and R^{a10} may be identical to or different from one another, and each independently represent a hydrogen atom, an organic substituent having 1 to 20 carbon atoms and optionally containing a heteroatom, or an inorganic substituent. Two groups R^{a9} and R^{a10} are optionally bonded to each other to form a ring.

In the formula (a1), R^{a1} to Ra5 may be identical to or different from one another, and each independently represent a hydrogen atom, an organic substituent having 1 to 20 carbon atoms and optionally containing a heteroatom, or an inorganic substituent. With regard to the organic substituent having 1 to 20 carbon atoms and optionally containing a heteroatom, when the organic substituent contains a heteroatom, the type of the heteroatom is not particularly limited, so long as the effects of the present invention are not impaired. Specific examples of the heteroatom include an oxygen atom, a nitrogen atom, a sulfur atom, a phosphorus atom, a silicon atom, a selenium atom, a halogen atom, etc.

The organic substituent is not particularly limited, so long as it does not inhibit the formation reaction of the metallocene compound represented by the formula (a1). Examples of the organic substituent include an alkyl group having 1 to 20 carbon atoms, an alkoxy group having 1 to 20 carbon atoms, a cycloalkyl group having 3 to 20 carbon atoms, an aliphatic acyl group having 2 to 20 carbon atoms, a benzoyl group, an α-naphthylcarbonyl group, a β-naphthylcarbonyl group, an aromatic hydrocarbon group having 6 to 20 carbon atoms, an aralkyl group having 7 to 20 carbon atoms, a trialkylsilyl group having 3 to 20 carbon atoms, a monosubstituted amino group substituted with a hydrocarbon group having 1 to 20 carbon atoms, and a disubstituted amino group substituted with a hydrocarbon group having 1 to 20 carbon atoms.

Among these organic substituents, an alkyl group having 1 to 6 carbon atoms, alkoxy group having 1 to 6 carbon atoms, a cycloalkyl group having 3 to 8 carbon atoms, an aliphatic acyl group having 2 to 6 carbon atoms, a benzoyl group, a phenyl group, a benzyl group, a phenethyl group and a trialkylsilyl group having 3 to 10 carbon atoms are preferable.

Among the organic substituents, a methyl group, an ethyl group, an n-propyl group, an isopropyl group, an n-butyl group, an isobutyl group, a sec-butyl group, a tert-butyl group, a methoxy group, an ethoxy group, an n-propyloxy group, an isopropyloxy group, an n-butyloxy group, an isobutyloxy group, a sec-butyloxy group, a tert-butyloxy group, an acetyl group, a propionyl group, a butanoyl group, a phenyl group, a trimethylsilyl group and a tert-butyldimethylsilyl group are more preferable.

The inorganic substituent is not particularly limited, so long as it does not inhibit the formation reaction of the metallocene compound represented by the formula (a1). Specific examples of the inorganic substituent include a halogen atom, a nitro group, an unsubstituted amino group, a cyano group, etc.

X represents an organic substituent having 1 to 20 carbon atoms and optionally containing a heteroatom, or a halogen atom. Specific examples and preferable examples of the organic substituent having 1 to 20 carbon atoms and optionally containing a heteroatom, as X, are the same as the specific examples and preferable examples of the organic substituent having 1 to 20 carbon atoms and optionally containing a heteroatom, as R^{a1} to R^{a5}. X represents preferably a halogen atom, more preferably a chlorine atom and a bromine atom, and particularly preferably a chlorine atom.

In the formula (ala), R^{a6} to R^{a8} may be identical to or different from one another, and each independently represent a hydrogen atom, an organic substituent having 1 to 20 carbon atoms and optionally containing a heteroatom, or an inorganic substituent, and n1 is an integer of 0 to 3. n1 is an integer of 0 to 3, preferably 0 or 1, and more preferably 0. Specific examples and preferable examples of the groups mentioned above for R^{a6} to R^{a8} in the formula (ala) are the same as the specific examples and preferable examples of the groups mentioned above for R^{a1} to R^{a5}_{.}

Preferable examples of the group represented by the formula (ala) include a phenoxy group, a 2,6-dimethylphenoxy group, and a 2,6-diisopropylphenoxy group.

In the formula (a1b), R^{a9} and R^{a10} may be identical to or different from one another, and each independently represent a hydrogen atom, an organic substituent having 1 to 20 carbon atoms and optionally containing a heteroatom, or an inorganic substituent. Two groups R^{a9} and R^{a10} are optionally bonded to each other to form a ring. Specific examples and preferable examples of the organic substituent having 1 to 20 carbon atoms and optionally containing a heteroatom, as R^{a9} and R^{a10}, are the same as the specific examples and preferable examples of the organic substituent having 1 to 20 carbon atoms and optionally containing a heteroatom, as R^{a1} to R^{a5}_{.} A monosubstituted amino group substituted with a hydrocarbon group having 1 to 20 carbon atoms, and a disubstituted amino group substituted with a hydrocarbon group having 1 to 20 carbon atoms are also preferable as the organic substituent. For the monosubstituted amino group or the disubstituted amino group as R^{a9} and R^{a10} in the formula (a1b), preferable examples of the hydrocarbon group having 1 to 20 carbon atoms, which is bonded to the nitrogen atom, include the hydrocarbon groups included in the preferable examples of the organic substituent for R^{a1} to R^{a5}. Specific examples of the inorganic substituent as R^{a9} and R^{a10} are the same as the specific examples of the inorganic substituent as R^{a1} to R^{a5}.

Preferable examples of the group represented by the formula (a1b) include the following groups.

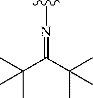

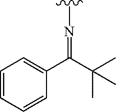

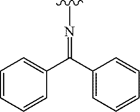

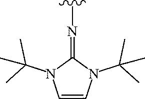

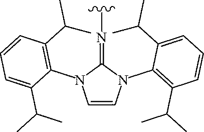

Preferable specific examples of the metallocene compound represented by the formula (a1), as described above, include the following metallocene compounds. Incidentally, M in the following formulas is the same as M in the formula (a1). In addition, in the following formulas, n-Bu represents an n-butyl group, tert-Bu represents a tert-butyl group, Si(Me)₃ represents a trimethylsilyl group, and Si (Me)₂tert-Bu represents a tert-butyldimethylsilyl group.

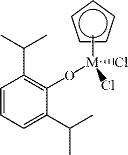

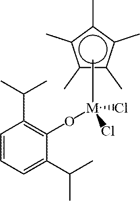

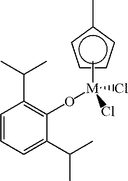

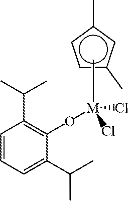

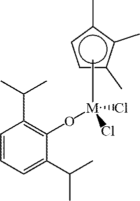

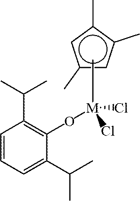

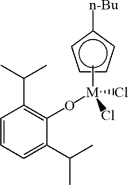

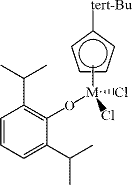

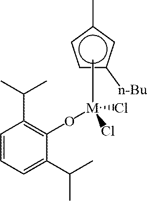

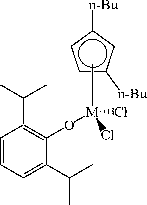

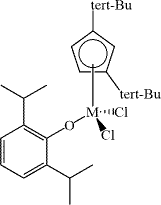

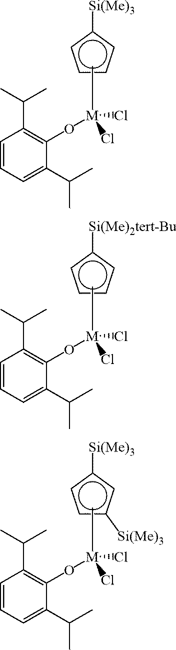

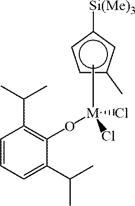

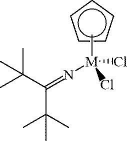

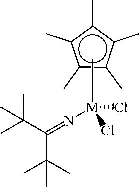

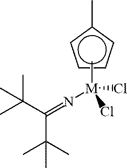

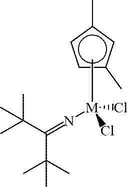

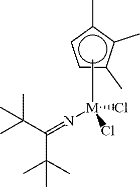

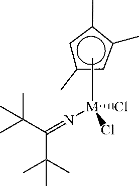

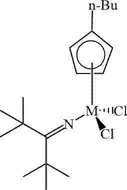

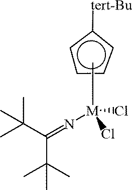

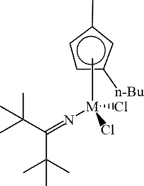

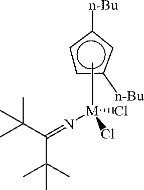

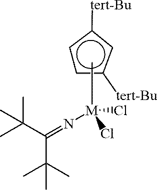

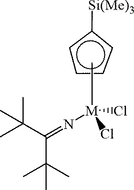

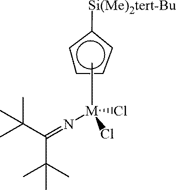

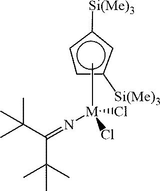

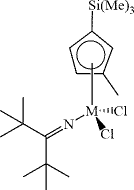

The monomers in the polymerization vessel are polymerized in the presence of the metallocene catalyst and an alkylmetal compound. The alkylmetal compound includes at least one selected from an alkylaluminum compound having at least one alkyl group bonded to an Al atom, or an alkylzinc compound having at least one alkyl group bonded to a Zn atom. The use of a combination of the metallocene catalyst described above and the alkylmetal compound allows for efficient production of a cyclic olefin copolymer by copolymerizing monomers including a norbornene monomer and ethylene while suppressing the formation of a polyethylene-like impurity and an excessive increase in molecular weight.

One type of the alkylmetal compound may be used alone, or two or more types of alkylmetal compounds may be used in combination.

An alkylaluminum compound which has been conventionally used in the polymerization of olefins or the like can be used as the alkylaluminum compound of the present invention without particular limitation. Examples of the alkylaluminum compound include a compound represented by the following general formula (II):

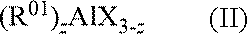

wherein in the formula (II), R⁰¹ represents an alkyl group having 1 to 15 carbon atoms, X represents a halogen atom or a hydrogen atom, and z1 represents an integer of 1 to 3.

The number of carbon atoms in the alkyl group as R⁰¹ is 1 to 15, in view of ease of obtaining desired effect, more preferably 1 to 8, and even more preferably 2 to 8. Suitable examples of the alkyl group include a methyl group, an ethyl group, an n-propyl group, an isopropyl group, an n-butyl group, an isobutyl group, an n-pentyl group, an n-hexyl group, an n-heptyl group, n-octyl group, etc.

Specific examples of the alkylaluminum compound include: trialkylaluminums such as trimethylaluminum, triethylaluminum, tri-n-propylaluminum, triisopropylaluminum, tri-n-butylaluminum, triisobutylaluminum, tri-sec-butylaluminum, tri-n-pentylaluminum, tri-n-hexylaluminum, tri-n-heptylaluminum, and tri-n-octylaluminum; dialkylaluminum halides such as dimethylaluminum chloride, diethylaluminum chloride, and diisobutylaluminum chloride; dialkylaluminum hydrides such as dimethylaluminum hydride, diethylaluminum hydride, di-n-propyldimethylaluminum hydride, diisopropyldimethylaluminum hydride, di-n-butylaluminum hydride, diisobutylaluminum hydride, di-sec-butylaluminum hydride, di-n-pentylaluminum hydride, di-n-hexylaluminum hydride, di-n-heptylaluminum hydride, and di-n-octylaluminum hydride; and dialkylaluminum alkoxides such as dimethylaluminum methoxide.

Alkylzinc compounds which have conventionally been used in the polymerization of olefins, etc. can be used as the alkylzinc compound of the present invention without particular limitation. Examples of the alkylzinc compound include compounds represented by the following general formula (III).

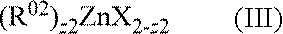

In the formula (II), R⁰² represents an alkyl group having 1 to 15 carbon atoms, preferably 1 to 8 carbon atoms, X represents a halogen atom or a hydrogen atom, and z2 represents an integer of 1 to 3.

The number of carbon atoms in the alkyl group as R⁰² is 1 to 15, preferably 1 to 8, and more preferably 2 to 8 in light of ease of the achievement of the desired effects. Preferable specific examples of the alkyl group include a methyl group, an ethyl group, an n-propyl group, an isopropyl group, an n-butyl group, an isobutyl group, an n-pentyl group, an n-hexyl group, an n-heptyl group, an n-octyl group, etc.

Specific examples of the alkylzinc compound include: dialkylzincs such as dimethylzinc, diethylzinc, di-n-propylzinc, diisopropylzinc, di-n-butylzinc, diisobutylzinc, di-sec-butylzinc, di-n-pentylzinc, di-n-hexylzinc, di-n-heptylzinc and di-n-octylzinc; alkylzinc halides such as methylzinc chloride, ethylzinc chloride and isobutylzinc chloride; and alkylzinc hydrides such as methylzinc hydride, ethylzinc hydride, and isobutylzinc hydride.

Among the alkylmetal compounds, one or more selected from the group consisting of a trialkylaluminum, a dialkylaluminum hydride and a dialkylzinc are preferable, and a trialkylaluminum and/or a dialkylaluminum hydride are more preferable.

The amount of the alkylmetal compound used together with the metallocene catalyst is preferably 1 to 500,000 moles, and more preferably 10 to 50,000 moles in terms of the sum of the moles of aluminum and the moles of zinc per mole of the metallocene catalyst.

The polymerization of the monomers is preferably performed in the presence of the metallocene catalyst as described above and a co-catalyst. A compound which is generally used as a co-catalyst in the polymerization of olefins can be used as the co-catalyst of the present invention without particular limitation. Suitable examples of the co-catalyst include an aluminoxane and an ionic compound. The polymerization of the monomers is performed, in particular, using preferably at least one selected from the aluminoxane or a borate compound as the ionic compound, and more preferably the aluminoxane, as the co-catalyst, in light of favorable progress of the polymerization reaction.

In other words, the polymerization of the monomers is performed preferably in the presence of the metallocene catalyst, the alkylmetal compound, and at least one selected from the aluminoxane or the borate compound, more preferably in the presence of the metallocene catalyst, the alkylmetal compound and the aluminoxane.

The metallocene catalyst described above is preferably mixed with the aluminoxane and/or the ionic compound to give a catalyst composition. The alkylmetal compound may be added to the catalyst composition, or fed to a polymerization vessel separately from the catalyst composition. In this regard, the ionic compound is a compound that forms a cationic transition metal compound through the reaction with the metallocene catalyst.

The catalyst composition is preferably prepared using a solution of the metallocene catalyst. A solvent contained in the solution of the metallocene catalyst is not particularly limited. Examples of a preferable solvent include hydrocarbon solvents such as pentane, hexane, heptane, octane, isooctane, isododecane, mineral oils, cyclohexane, methylcyclohexane, decahydronaphthalene (decalin), mineral oils, benzene, toluene and xylene, and halogenated hydrocarbon solvents such as chloroform, methylene chloride, dichloromethane, dichloroethane and chlorobenzene.

The amount of the solvent used is not particularly limited so long as a catalyst composition having the desired performance can be produced. Typically, an amount of solvent is used such that the concentration of the metallocene catalyst, the aluminoxane and the ionic compound is preferably 0.00000001 to 100 mol/L, more preferably 0.00000005 to 50 mol/L, and particularly preferably 0.0000001 to 20 mol/L.

In mixing liquids containing basic ingredients of the catalyst composition, the liquids are preferably mixed such that a value of (M_{b1} + M_{b2}) /Mₐ, wherein Mₐ represents the number of moles of the transition metal element in the metallocene catalyst, M_{b1} represents the number of moles of aluminum in the aluminoxane, and M_{b2} represents the number of moles of the ionic compound, is preferably 1 to 200,000, more preferably 5 to 100,000, and particularly preferably 10 to 80,000.

The temperature at which the liquids containing the basic ingredients of the catalyst composition are mixed is not particularly limited, and is preferably -100 to 100° C., and more preferably -50 to 50° C.

The mixing of a solution of the metallocene catalyst with the aluminoxane and/or the ionic compound for the preparation of the catalyst composition may be performed prior to the polymerization in an apparatus separate from the polymerization vessel, or may be performed prior to or during the polymerization in the polymerization vessel.

In the following, materials used in the preparation of the catalyst composition, and conditions for the preparation of the catalyst composition will be described.

### Aluminoxane

Various aluminoxanes which have conventionally been used as a co-catalyst, etc. in the polymerization of various olefin can be used as the aluminoxane of the present invention without particular limitation. Typically, the aluminoxane is an organic aluminoxane. In the production of the catalyst composition, one type of the aluminoxane may be used alone, and two or more types of aluminoxanes may be used in combination.

An alkylaluminoxane is preferably used as the aluminoxane. Examples of the alkylaluminoxane include a compound represented by the following formula (b1-1) or (b1-2). The alkylaluminoxane represented by the following formula (b1-1) or (b1-2) is a product of the reaction of trialkylaluminum with water.

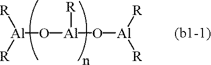

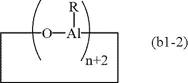

In the formulas (b1-1) and (b1-2), R represents an alkyl group having 1 to 4 carbon atoms, and n represents an integer of 0 to 40, preferably 2 to 30.

The alkylaluminoxane includes methylaluminoxane, and a modified methylaluminoxane in which a part of methyl groups in the methylaluminoxane are replaced with another alkyl group. The modified methylaluminoxane is preferably, for example, a modified methylaluminoxane having, as a replacing alkyl group, an alkyl group having 2 to 4 carbon atoms, such as an ethyl group, a propyl group, an isopropyl group, a butyl group and an isobutyl group, and, in particular, more preferably a modified methylaluminoxane in which a part of methyl groups in the methylaluminoxane are replaced with an isobutyl group. Specific examples of the alkylaluminoxane include methylaluminoxane, ethylaluminoxane, propylaluminoxane, butylaluminoxane, isobutylaluminoxane, methylethylaluminoxane, methylbutylaluminoxane, methylisobutylaluminoxane, etc., and among these, methylaluminoxane and methylisobutylaluminoxane are preferable.

The alkylaluminoxane can be prepared by any known method. Alternatively, commercially available products of the alkylaluminoxane may be used. Examples of the commercially available products of the alkylaluminoxane include MMAO-3A, TMAO-200 series, TMAO-340 series, solid MAO (each manufactured by Tosoh Finechem Corporation) and a methylaluminoxane solution (manufactured by Albemarle Corporation), etc. More preferably, an alkylaluminoxane other than solid MAO is used in light of the tendency toward reliable suppression of the formation of the polyethylene-like impurity.

### Ionic Compound

The ionic compound forms a cationic transition metal compound upon the reaction with the metal-containing catalyst. An ionic compound having an ion such as a tetrakis(pentafluorophenyl)borate anion, an amine cation having an active proton such as dimethylphenylammonium cation ((CH₃) ₂N (C₆H₅) H⁺), a trisubstituted carbonium cation such as (C₆H₅)₃C⁺, a carborane cation, a metal carborane cation and a ferrocenium cation having a transition metal may be used as the ionic compound.

Suitable examples of the ionic compound include a borate. Specific examples of a preferable borate include trityl tetrakis(pentafluorophenyl)borate, dimethylphenylammonium tetrakis(pentafluorophenyl)borate and an N-methyldialkylammonium tetrakis(pentafluorophenyl)borate such as N,N-dimethylanilinium tetrakis(pentafluorophenyl)borate and N-methyldi-n-decylammonium tetrakis(pentafluorophenyl)borate.

Further, one or more selected from an aluminoxane, an aromatic compound having one or more phenolic hydroxyl groups and one or more halogen atoms on its aromatic ring, or a hindered phenol are preferably contained in the polymerization vessel prior to the addition of the metallocene catalyst, or the catalyst composition containing the metallocene catalyst, in light of the tendency toward the production of the cyclic olefin copolymer in favorable yields. The aromatic compound having one or more phenolic hydroxyl groups and one or more halogen atoms has at least one aromatic ring having at least one of the one or more phenolic hydroxyl groups and at least one of the one or more halogen atoms bonded thereto, and the aromatic ring(s) may be a monocyclic ring or a fused ring. The hindered phenol is a phenol having a bulky substituent in at least one of two positions adjacent to the position of a phenolic hydroxyl group. Examples of the bulky substituent include an alkyl group other than a methyl group, such as an isopropyl group, an isobutyl group, a sec-butyl group and a tert-butyl group, an alkenyl group, an alkynyl group, an aryl group, a heterocyclic group, an alkoxy group, an aryloxy group, a substituted amino group, an alkylthio group, an arylthio group, etc.

Specific examples of the hindered phenol include 2,6-di-tert-butyl-p-cresol (BHT), 2,6-di-tert-butylphenol, 2-tert-butylphenol, 2-tert-butyl-p-cresol, 3,3′,5,5′-tetra-tert-butyl-4,4′-dihydroxybiphenyl, 3,3′,5,5′-tetra-tert-butyl-2,2′-dihydroxybiphenyl, 4,4′-butylidenebis(3-methyl-6-tert-butylphenol), 2,2′-methylenebis(6-tert-butyl-4-methylphenol), 4,4′,4″-(1-methylpropanyl-3-ylidene)tris(6-tert-butyl-m-cresol), and 1,3,5-tris(3,5-di-tert-butyl-4-hydroxyphenylmethyl)-2,4,6-trimethylbenzene, etc. Among these, 2,6-di-tert-butyl-p-cresol (BHT) and 2,6-di-tert-butylphenol are preferable in light of their low molecular weight and their tendency toward the achievement of the desired effects in the use of a small amount of the hindered phenol. The hindered phenol reacts with the alkylaluminum compound in the polymerization system and contributes to an increase in yield of the cyclic olefin copolymer. Thus, the hindered phenol is preferably used with the alkylaluminum. The hindered phenol may be mixed with the alkylaluminum in a polymerization reactor and used. A mixture obtained by mixing the alkylaluminum and the hindered phenol prior to the polymerization may be introduced into a polymerization reactor.

The aluminoxane is as described in relation to the production method of the catalyst composition.

In the case where the aluminoxane is added to the polymerization vessel prior to the addition of the metallocene catalyst, or the catalyst composition containing the metallocene catalyst, the amount of the aluminoxane used is preferably 1 to 1,000,000 moles, and more preferably 10 to 100,000 moles in terms of the number of moles of aluminum in the aluminoxane per mole of the metallocene catalyst.

The polymerization is preferably performed in the presence of the metallocene catalyst and the aluminoxane, or in the presence of the metallocene catalyst, the ionic compound and the hindered phenol.

The polymerization conditions are not limited, so long as a cyclic olefin copolymer having the desired physical properties, and any known conditions may be employed. The amount of the catalyst composition used is derived from the amount of the metallocene compound used in the preparation of the catalyst composition. The amount of the catalyst composition used per mole of the norbornene monomer is preferably 0.000000001 to 0.005 moles, and more preferably 0.00000001 to 0.0005 moles in terms of the amount of the metallocene compound used in the preparation of the catalyst composition.

The polymerization time is not particularly limited, and the polymerization is performed until the desired yield is reached or the molecular weight of the polymer is increased to the desired degree. The polymerization time also varies depending on the temperature, the catalyst composition and the monomer composition, and is typically 0.01 h to 120 h, preferably 0.1 h to 80 h, and more preferably 0.2 h to 10 h.

It is preferable that at least a part, and preferably the entirety, of the catalyst composition is continuously added to the polymerization vessel. The continuous addition of the catalyst composition allows for continuous production of the cyclic olefin copolymer, and leads to the reduction of production costs of the cyclic olefin copolymer.

The method described above can efficiently produce the cyclic olefin copolymer by copolymerizing the monomers including the norbornene monomer and ethylene while suppressing the formation of a polyethylene-like impurity. The glass transition temperature of the resulting cyclic olefin copolymer is not particularly limited, and is, for example, preferably 185° C. or lower, more preferably 160° C. or lower, even more preferably 130° C. or lower, still more preferably 120° C. or lower, and particularly preferably 100° C. or lower. Further, when a sample of the cyclic olefin copolymer produced according to the method described above is subjected to the measurement according to the method defined in JIS K7121 using a differential scanning calorimeter (DSC) in a nitrogen atmosphere under the condition of a rate of temperature increase of 20° C./min, the obtained DSC curve preferably shows no peak of the melting point (enthalpy of fusion) assigned to the polyethylene-like impurity.

This means no or very little polyethylene-like impurity in the cyclic olefin copolymer. It should be noted that in the presence of the polyethylene-like impurity in the cyclic olefin copolymer, a peak of the melting point assigned to the polyethylene-like impurity on the DSC curve will be generally detected in the range of 100° C. to 140° C.

The cyclic olefin copolymer produced according to the method described above contains a trace amount of the polyethylene-like impurity and is excellent in transparency. Therefore, the cyclic olefin copolymer produced according to the method described above is particularly preferably used for, e.g., materials of optical films or sheets, and films or sheets for packaging materials, which are required to have a high degree of transparency from the viewpoints of optical function and aesthetics.

### EXAMPLES

In the following, the present invention is specifically described with reference to Examples, but the present invention is not limited to these Examples.

### Examples 1 to 19, and Comparative Example 1

In Examples and Comparative Example, the compound C1 shown below was used as a metallocene catalyst in the production of a cyclic olefin resin composition.

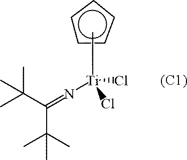

In Examples and Comparative Example, a 6.5% by mass (in terms of the content of the Al atom) MMAO-3A solution in toluene (a solution of a methylisobutylaluminoxane represented by [(CH₃) ₀.₇ (iso-C₄H₉) ₀.₃AlO] ₙ; from Tosoh Finechem Corporation; this solution contained 6 mol% of trimethylaluminum based on the total Al) was used as a co-catalyst.

Toluene and 90 mmol of 2-norbornene were added to a 150 mL, adequately-dried stainless-steel autoclave containing a stirring bar. A co-catalyst in the amount specified in Table 1 and an alkylmetal compound of the type and in the amount specified in Table 1 were then added to the autoclave. In Comparative Example, no alkylmetal compound was used. The autoclave was heated until the polymerization temperature reached 90° C., and thereafter a solution of the metallocene catalyst was added such that the amount of the metallocene catalyst was 0.08 µmol. The solution of the metallocene catalyst was prepared in toluene. Next, an ethylene pressure (gauge pressure) of 0.6 MPa was applied, and the time when 30 seconds had elapsed after the application of the ethylene pressure was considered to be the polymerization starting point. Incidentally, the total volume of the monomer solution immediately before the application of the ethylene pressure was 80 mL. Fifteen minutes after the start of the polymerization, the ethylene feed was stopped, the pressure was carefully reduced to the atmospheric pressure, and then isopropyl alcohol was added to the reaction solution to quench the reaction. Subsequently, the polymerization solution was poured into a solvent mixture of 300 mL of acetone, 200 mL of methanol or isopropyl alcohol, and 5 mL of hydrochloric acid to precipitate the copolymer. The copolymer was collected via suction filtration, followed by washing with acetone and methanol, and then the copolymer was dried in vacuo at 110° C. for 12 h, to give a copolymer of norbornene and ethylene. The copolymer yield (g) per gram of the catalyst, which is calculated from the amount of the catalyst used and the amount of the copolymer thus obtained, is listed in Table 1.

In addition, the measurement of the glass transition temperature and the molecular weight, the thermal analysis for an impurity and a turbidity test, for confirming the presence or absence of the polyethylene-like impurity were performed according to the following methods. As a result of the turbidity test, no turbidity was found in all Examples and Comparative Example. The measurement results of the glass transition temperature and the molecular weight and the results of the thermal analysis for the impurity are shown in Table 1.

### Glass Transition Temperature (Tg)

The Tg of the cyclic olefin copolymer was measured according to the DSC method (method defined in JIS K7121). DSC apparatus: differential scanning calorimeter (DSC-Q1000, from TA Instrument)
measurement atmosphere: nitrogen
condition for temperature increase: 20° C./min

### Molecular Weight Measurement

The number-average molecular weight (Mn) and the weight-average molecular weight (Mw) were measured by gel permeation chromatography under the following measurement conditions. apparatus: Viscotek TDA302 Detector and Pump Autosampler apparatus from Malvern
detector: RI
solvent: toluene
column: TSKgel GMHHR-M (300 mm × 7.8 mmφ) from Tosoh Corporation
flow rate: 1 mL/min
temperature: 75° C.
sample concentration: 2.5 mg/mL
injection volume: 100 µL
standard samples: monodisperse polystyrenes

### Thermal Analysis for Impurity

The amount of exotherm (mJ/mg) was calculated based on an area of a peak assigned to the melting point of the polyethylene-like impurity, which was observed in the range of 100° C. to 140° C. on the DSC curve obtained in the measurement of the glass transition temperature. A larger calculated amount of exotherm indicates a higher content of the polyethylene-like impurity. It should be noted that “ND” in Table 1 indicates that no peak assigned to the melting point of the polyethylene-like impurity was detected on the DSC curve.

### Turbidity Test

After the dissolution of 0.1 g of the obtained cyclic olefin copolymer in 10 g of toluene, the presence or absence of the turbidity in the solution was observed. When turbidity is found, the polyethylene-like impurity is contained in the cyclic olefin copolymer. When no turbidity is found, no polyethylene-like impurity is contained in the cyclic olefin copolymer.

In Table 1, Et represents an ethyl group, ⁱPr represents an isopropyl group, ⁱBu represents an isobutyl group, and Oct represents an octyl group.

[TABLE 1]

| | Alkylmetal compound | | Co-catalyst/ transition metal molar ratio | Mn×10⁻³ | Mw×10⁻³ | Copolymer yield per gram of catalyst g/g | Tg °C | Thermal analysis for impurity mJ/mg |
|---|---|---|---|---|---|---|---|---|
| | Type | Amount µmol | | | | | | |
| Ex. 1 | ZnEt₂ | 40 | 10000 | 154 | 312 | 22200 | 96 | ND |
| Ex. 2 | ZnEt₂ | 200 | 10000 | 43 | 84 | 19600 | 90 | ND |
| Ex. 3 | ZnⁱPr₂ | 40 | 10000 | 143 | 256 | 14200 | 93 | ND |
| Ex. 4 | ZnⁱPr₂ | 200 | 10000 | 79 | 177 | 34500 | 94 | ND |
| Ex. 5 | AlⁱBu₃ | 40 | 10000 | 210 | 483 | 34000 | 94 | ND |
| Ex. 6 | AlⁱBu₃ | 200 | 10000 | 251 | 506 | 31400 | 95 | ND |
| Ex. 7 | AlEt₃ | 40 | 10000 | 126 | 323 | 25700 | 97 | ND |
| Ex. 8 | AlEt₃ | 200 | 10000 | 62 | 137 | 10900 | 94 | ND |
| Ex. 9 | AlⁱBu₂H | 100 | 10000 | 128 | 288 | 27600 | 101 | ND |
| Ex. 10 | AlⁱBu₂H | 200 | 10000 | 149 | 300 | 34400 | 92 | ND |
| Ex. 11 | AlⁱBu₂H | 400 | 10000 | 117 | 275 | 25900 | 93 | ND |
| Ex. 12 | AlEt₂Cl | 100 | 10000 | 159 | 362 | 23400 | 97 | ND |
| Ex. 13 | AlEt₂Cl | 200 | 10000 | 106 | 258 | 23200 | 93 | ND |
| Ex. 14 | AlEt₂Cl | 400 | 10000 | 62 | 164 | 9300 | 97 | ND |
| Ex. 15 | AlⁱBu₂H | 30 | 30000 | 88 | 169 | 18900 | 93 | ND |
| Ex. 16 | AlⁱBu₂H | 60 | 30000 | 87 | 156 | 17300 | 95 | ND |
| Ex. 17 | AlⁱBu₂H | 180 | 30000 | 66 | 127 | 11600 | 91 | ND |
| Ex. 18 | AlⁱBu₂H | 400 | 30000 | 62 | 112 | 9600 | 100 | ND |
| Ex. 19 | AlⁱBu₂H | 1000 | 30000 | 45 | 87 | 12100 | 99 | ND |
| Comp. Ex. 1 | - | - | 10000 | 324 | 554 | 33700 | 105 | ND |

### Example 20, and Comparative Example 2

A copolymer of 2-norbornene and ethylene was obtained in the same manner as in Example 1 except that the amount of the norbornene charged was changed to 45 mmol, the charge pressure of ethylene was changed to 0.9 MPa (gauge pressure), the amount of the metallocene catalyst was changed to 0.5 µmol, the type and amount of the alkylmetal compound added and the amount of the co-catalyst added were changed as specified in Table 2, and the solvent was changed to decalin. In Comparative Example 2, no alkylmetal compound was used. The copolymer yield (g) per gram of the catalyst, which is calculated from the amount of the catalyst used and the amount of the copolymer thus obtained is shown in Table 2.

The measurement of the glass transition temperature and the molecular weight, the thermal analysis for an impurity and a turbidity test, for confirming the presence or absence of the polyethylene-like impurity were performed in the same manner as in Example 1. As a result of the turbidity test, no turbidity was found in all Example and Comparative Example. The measurement results of the glass transition temperature, the molecular weight and the thermal analysis for the impurity are shown in Table 2.

[TABLE 2]

| | Alkylmetal compound | | Co-catalyst/ transition metal molar ratio | Mnx10⁻³ | Mwx10⁻³ | Copolymer yield per gram of catalyst g/g | Tg °C | Thermal analysis for impurity mJ/mg |
|---|---|---|---|---|---|---|---|---|
| | Type | Amount µmol | | | | | | |
| Ex. 20 | AlⁱBu₂H | 200 | 3000 | 28 | 117 | 1900 | 54 | ND |
| Comp. Ex. 2 | - | - | 3000 | 51 | 236 | 2200 | 55 | ND |

It can be seen from comparison between Examples 1 to 19 and Comparative Example 1 or comparison between Example 20 and Comparative Example 2 that in the copolymerization of the monomers including the norbornene monomer and ethylene in the presence of the metallocene catalyst alone, a cyclic olefin copolymer of a norbornene monomer and ethylene can be efficiently obtained by the copolymerization of monomers including the norbornene monomer and ethylene in the presence of the metallocene catalyst satisfying the predetermined requirements as described above, and the alkylaluminum compound or alkylzinc compound satisfying the predetermined requirements as described above, while the formation of a polyethylene-like impurity, and an excessive increase in molecular weight are suppressed.

1. A method for producing a cyclic olefin copolymer comprising a structural unit derived from a norbornene monomer and a structural unit derived from ethylene, the method comprising:
charging at least the norbornene monomer and ethylene as monomers into a polymerization vessel;
polymerizing the monomers in the polymerization vessel in presence of a metallocene catalyst and an alkylmetal compound,
wherein the alkylmetal compound comprises at least one selected from the group consisting of an alkylaluminum compound having at least one alkyl group bonded to an Al atom, or an alkylzinc compound having at least one alkyl group bonded to a Zn atom, and
the metallocene catalyst has a ligand comprising a cyclopentadiene ring, and a structure in which a heteroatom being N, O, S or P is bonded to a transition metal of Group IV of periodic table and an sp2 carbon.

2. The method for producing a cyclic olefin copolymer according to claim 1, wherein the metallocene catalyst is represented by formula (a1): 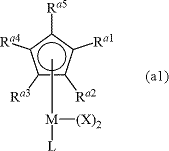
wherein in the formula (a1), M represents Ti, Zr or Hf, R^{a1} to R^{a5} are identical to or different from one another, and each independently represents a hydrogen atom, an organic substituent having 1 to 20 carbon atoms and optionally containing a heteroatom, or an inorganic substituent, wherein two groups adjacent on the 5-membered ring of R^{a1} to R^{a5} are optionally bonded to each other to form a ring, X represents an organic substituent having 1 to 20 carbon atoms and optionally containing a heteroatom or a halogen atom, and L represents a group represented by formula (a1a) or (a1b): 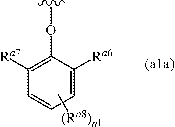 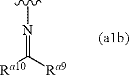
wherein in the formula (a1a), R^{a6} to R^{a8} are identical to or different from one another, and each independently represents a hydrogen atom, an organic substituent having 1 to 20 carbon atoms and optionally containing a heteroatom, or an inorganic substituent, and n1 is an integer of 0 to 3, and
wherein in the formula (a1b), R^{a9} and R^{a10} are identical to or different from one another, and each independently represents a hydrogen atom, an organic substituent having 1 to 20 carbon atoms and optionally containing a heteroatom, or an inorganic substituent, and two groups R^{a9} and R^{a10} are optionally bonded to each other to form a ring.

3. The method for producing a cyclic olefin copolymer according to claim 1, wherein the transition metal of Group IV of the periodic table is Ti.

4. The method for producing a cyclic olefin copolymer according to claim 1, wherein the polymerizing of the monomers is performed in the presence of the metallocene catalyst, the alkylmetal compound, and at least one selected from the group consisting of an aluminoxane or a borate compound.

5. The method for producing a cyclic olefin copolymer according to claim 1, wherein the polymerizing of the monomers is performed in the presence of the metallocene catalyst, the alkylmetal compound, and an aluminoxane.

6. The method for producing a cyclic olefin copolymer according to claim 1, wherein the alkylaluminum compound has at least one branched alkyl group bonded to an Al atom and having 2 to 8 carbon atoms, and the alkylzinc compound has at least one branched alkyl group bonded to a Zn atom and having 2 to 8 carbon atoms.

7. The method for producing a cyclic olefin copolymer according to claim 1, wherein the alkylmetal compound comprises one or more selected from the group consisting of trialkylaluminum, dialkylaluminum hydride, and dialkylzinc.

8. The method for producing a cyclic olefin copolymer according to claim 7, wherein the alkylmetal compound comprises at least one selected from the group consisting of trialkylaluminum or dialkylaluminum hydride.

9. The method for producing a cyclic olefin copolymer according to claim 1, wherein a DSC curve obtained in measurement of a sample of the cyclic olefin copolymer according to a method defined in JIS K7121 using a differential scanning calorimeter in a nitrogen atmosphere under a condition of a rate of temperature increase of 20° C./min shows no peak of a melting point assigned to a polyethylene-like impurity in a range of 100° C. to 140° C.
